(19) United States
(12) Patent Application Publication
(10) Pub. No.: US 2026/0269717 A1
(43) Pub. Date: Sep. 10, 2026

(54) POWER CONVERTER WITH LOW ELECTROMAGNETIC INTERFERENCE AND OPERATING METHOD THEREOF

(71) Applicant: Delta Electronics, Inc., Taoyuan City (TW)

(72) Inventor: SHANG KAY YANG, Taoyuan City (TW)

(21) Appl. No.: 19/190,606

(22) Filed: Apr. 26, 2025

(30) Foreign Application Priority Data
Mar. 4, 2025 (CN) 202510247661.2

(51) Int. Cl. H02M 1/44; H02M 1/00; H02M 3/335

(52) U.S. Cl. CPC H02M 1/44; H02M 1/0025; H02M 3/33573; H02M 3/33592

(57) ABSTRACT

A power converter has a first bridge arm, two transformers, a secondary side unit, a signal generator, and a frequency adjuster. The transformers are coupled between the first bridge arm and the secondary side unit. The frequency adjuster is coupled to the signal generator. The signal generator provides control signals to a first switch and a second switch of the first bridge arm, respectively. The frequency jitter mechanism is used to operate a switching frequency of the frequency adjuster between a frequency increasing mode and a frequency decreasing mode. The energy concentration of the control signal in a specific frequency band can be reduced to effectively reduce the energy peak of electromagnetic interference in a single frequency band.

### CROSS REFERENCE TO RELATED APPLICATIONS

This application claims priority to China Application Serial Number 202510247661.2, filed on Mar. 4, 2025, which is incorporated herein by reference.

### FIELD OF INVENTION

The present disclosure relates to a power converter, in particular to a power converter with low electromagnetic interference and an operating method thereof.

### BACKGROUND OF INVENTION

To increase the power density of power supplies, high-frequency switching techniques have been adopted in recent years for power conversion operations to reduce the size of magnetic components. However, the electromagnetic interference (EMI) caused by the high-frequency control signals of the switching transistors and their harmonics will cause the power supply to fail the EMI test, resulting in challenges in EMI design.

As a result, it is necessary to provide a power converter to solve the problems existing in the conventional technologies, as described above.

### SUMMARY OF INVENTION

The object of the present disclosure is to provide a power converter with low electromagnetic interference and an operating method thereof to solve the above technical problems.

According to the aforementioned object, a power converter is provided. The power converter comprises: a first bridge arm comprising a first switch and a second switch connected in series at a first connection point; two transformers, wherein two primary sides of the two transformers are connected in series and defined as a primary series winding coupled to the first connection point, and two secondary sides of the two transformers are connected in series and defined as a secondary series winding; a secondary side unit coupled to the secondary series winding; a signal generator configured to provide a plurality of control signals to the first switch and the second switch, respectively, so as to control at least one of a conduction state and conduction frequency of the first switch and the second switch; and a frequency adjuster configured to provide a switching frequency correspondingly according to an input frequency and a frequency jitter value; wherein the signal generator receives the switching frequency and sets frequencies of the plurality of control signals according to the switching frequency; the frequency adjuster is configured to operate in one of a frequency increasing mode and a frequency decreasing mode; in the frequency increasing mode, the frequency jitter value is increased until the frequency jitter value reaches a predetermined maximum value, and then the frequency adjuster operates in the frequency decreasing mode; in the frequency decreasing mode, the frequency jitter value is reduced until the frequency jitter value reaches a predetermined minimum value, and then the frequency adjuster operates in the frequency increasing mode.

According to an embodiment of the present disclosure, the power converter further comprises a second bridge arm connected in parallel to the first bridge arm; the second bridge arm comprises a third switch and a fourth switch; the third switch and the fourth switch are connected in series at a second connection point; and the primary series winding is coupled between the first connection point and the second connection point.

According to an embodiment of the present disclosure, the signal generator generates a first control signal, a second control signal, a third control signal, and a fourth control signal to control the first switch, the second switch, the third switch, and the fourth switch, respectively; the first control signal is complementary to the second control signal, and the third control signal is complementary to the fourth control signal.

According to an embodiment of the present disclosure, the power converter further comprises an input capacitor coupled to the second switch, and the primary series winding is coupled between the first connection point and the input capacitor.

According to an embodiment of the present disclosure, the power converter further comprises a first capacitor and a second capacitor connected in series at a second connection point and defined as a capacitor group connected in parallel to the first bridge arm; and the primary series winding is coupled between the first connection point and the second connection point.

According to an embodiment of the present disclosure, the power converter further comprises a voltage controller coupled to the signal generator to generate a control variable for the signal generator.

According to an embodiment of the present disclosure, the power converter further comprises a subtractor coupled to the voltage controller; the subtractor is configured to receive a feedback voltage and a reference voltage to calculate an error value; the feedback voltage is generated according to an output voltage of the secondary side unit; and the reference voltage is corresponding to a reference voltage value of the output voltage.

According to an embodiment of the present disclosure, the frequency adjuster comprises a frequency jitter controller and a comparator coupled to the frequency jitter controller; the frequency jitter controller is configured to output a frequency jitter value; and the comparator is configured to calculate a sum of the frequency jitter value and the switching frequency generated by the frequency adjuster.

According to an embodiment of the present disclosure, the secondary side unit comprises a half-bridge rectifier circuit and an output capacitor; the output capacitor is coupled to the half-bridge rectifier circuit; and the output capacitor is configured to couple a load.

According to the aforementioned object, an operating method of a power converter with low electromagnetic interference is provided. The operating method comprises steps of: providing a first bridge arm, two transformers, a secondary side unit, a signal generator, and a frequency adjuster, wherein the transformers are coupled between the first bridge arm and the secondary side unit, and the frequency adjuster is coupled to the signal generator; operating the frequency adjuster in a frequency increasing mode and a frequency decreasing mode to make the frequency adjuster provide a switching frequency correspondingly according to an input frequency and a frequency jitter value; in the frequency increasing mode, the frequency jitter value is increased until the frequency jitter value reaches a predetermined maximum value, and then the frequency adjuster operates in frequency decreasing mode; and in the frequency decreasing mode, the frequency jitter value is reduced until the frequency jitter value reaches a predetermined minimum value, and then the frequency adjuster operates in the frequency increasing mode; receiving the switching frequency through the signal generator and setting frequencies of a plurality of control signals according to the switching frequency; and providing the plurality of control signals through the signal generator to a first switch and a second switch of the first bridge arm, respectively, so as to control at least one of a conduction state and conduction frequency of the first switch and the second switch.

According to an embodiment of the present disclosure, the operating method further comprises: generating a first control signal, a second control signal, a third control signal, and a fourth control signal by the signal generator; and controlling the first switch, the second switch, the third switch, and the fourth switch, respectively by the first control signal, the second control signal, the third control signal, and the fourth control signal, wherein the first control signal is complementary to the second control signal, and the third control signal is complementary to the fourth control signal.

According to an embodiment of the present disclosure, wherein the power converter comprises a voltage controller coupled to the signal generator, the operating method further comprises: generating a control variable for the signal generator by the voltage controller.

According to an embodiment of the present disclosure, wherein the power converter comprises a subtractor coupled to the voltage controller, the operating method further comprising: receiving a feedback voltage and a reference voltage to calculate an error value by the subtractor, wherein the feedback voltage is generated according to an output voltage of the secondary side unit and the reference voltage is corresponding to a reference voltage value of the output voltage.

According to an embodiment of the present disclosure, wherein the frequency adjuster comprises a frequency jitter controller and a comparator coupled to the frequency jitter controller, the operating method further comprises: outputting a frequency jitter value by the frequency jitter controller; and calculating a sum of the frequency jitter value and the switching frequency generated by the frequency adjuster through the comparator.

As described above, the embodiment uses the frequency jitter mechanism to operate the switching frequencies of the frequency adjuster between the frequency increasing mode and the frequency decreasing mode. The switching frequencies of the power converter and the electromagnetic interference signals of the multiples of the switching frequencies are dispersed at various frequencies at different time periods, thereby reducing the energy concentration in a specific frequency band of the control signals, which can effectively reduce the energy peak of the electromagnetic interference in a single frequency band.

### DESCRIPTION OF DRAWINGS

FIG. 1 is a circuit diagram of a power converter according to an embodiment of the present disclosure.

FIG. 2 is a circuit diagram of another power converter according to an embodiment of the present disclosure.

FIG. 3 is a circuit diagram of another power converter according to an embodiment of the present disclosure.

FIG. 4 is a circuit block diagram of a control unit of FIG. 1 according to the embodiment of the present disclosure.

FIG. 5 is a timing diagram of the control signals of FIG. 4 according to the embodiment of the present disclosure.

FIG. 6 is a circuit block diagram of a control unit of FIG. 2 or FIG. 3 according to the embodiment of the present disclosure.

FIG. 7 is a timing diagram of the control signals of FIG. 6 according to the embodiment of the present disclosure.

### DETAILED DESCRIPTION OF PREFERRED EMBODIMENTS

In order to make the above and other purposes, features, and advantages of the present disclosure more comprehensible, preferred embodiments of the present disclosure will be described below in detail together with the attached drawings. It should be noted that the drawings are simplified schematic diagrams and therefore only show the components and combination relationships related to the present disclosure to provide a clearer description of the basic structure or implementation method of the present disclosure, while the actual components and layout may be more complicated. Additionally, for the purpose of illustration, the components shown in the drawings of the present disclosure are not drawn to scale in terms of actual number, shape, or size. The detailed proportions can be adjusted according to design requirements.

As the demand for electric vehicle endurance continues to increase, the output power of the charging module also increases accordingly. The full-bridge converter chosen for the auxiliary power module (APM) of electric vehicles can provide high efficiency and high-power density, effectively meeting the needs for lightweight design and efficient operation in electric vehicles. Full-bridge converters can adapt to a wide range of input and output voltage levels, allowing them to flexibly respond to the varying voltage demands within electric vehicles. The full-bridge converters typically feature good electrical isolation, ensuring safety and reliability between the high-voltage power supply and the low-voltage control circuitry. In addition, the two-transformer full bridge converter is capable of soft-switching the primary side switch across the full load range and does not require additional components such as output inductors.

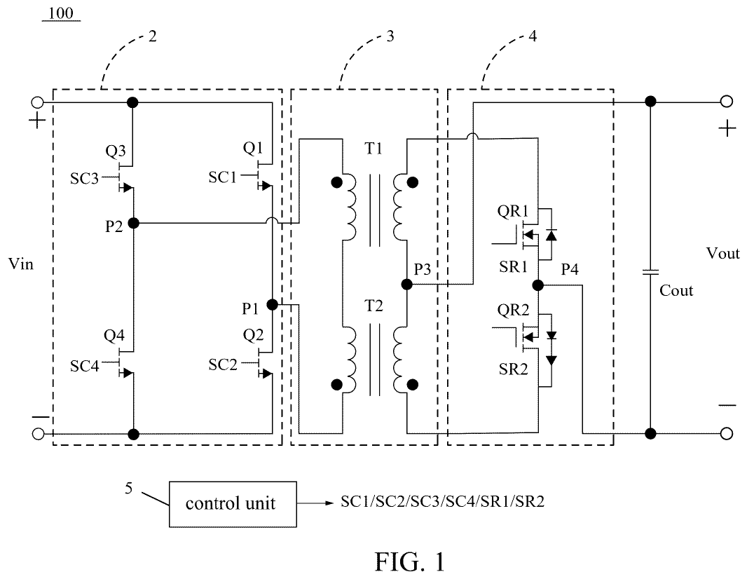

Please refer to FIG. 1, which is a circuit diagram of a power converter 100 according to an embodiment of the present disclosure, including the two-transformer full bridge converter, the power converter 100 comprises a switch unit 2, a transformer unit 3, a secondary side unit 4, and a control unit 5. The detailed structure, connection relationship and operation principles of each component will be described in detail below.

The switch unit 2 comprises a first bridge arm and a second bridge arm, wherein the first bridge arm comprises a first switch Q1 and a second switch Q2, and the first switch Q1 and the second switch Q2 are connected in series at a first connection point P1. The second bridge arm is connected in parallel to the first bridge arm. The second bridge arm comprises a third switch Q3 and a fourth switch Q4. The third switch Q3 and the fourth switch Q4 are connected in series at a second connection point P2. In the embodiment, the control unit 5 can be implemented by a microprocessor (MCU), a digital signal processor (DSP), an application specific integrated circuit (ASIC), other suitable analog circuits and/or digital circuits, or a combination of software and hardware. The control unit 5 is electrically connected to the first switch Q1, the second switch Q2, the third switch Q3 and the fourth switch Q4 of the switch unit 2, and outputs a first control signal SC1, a second control signal SC2, a third control signal SC3, and a fourth control signal SC4, respectively, used to control the conduction state of the first switch Q1, the second switch Q2, the third switch Q3 and the fourth switch Q4 to perform power conversion operation, and the third control signal SC3 is complementary to the fourth control signal SC4.

The transformer unit 3 comprises two transformers T1 and T2. The two primary sides of the two transformers T1 and T2 are defined as a primary series winding, and the primary series winding is coupled between the first connection point P1 and the second connection point P2. The secondary sides of the two transformers T1 and T2 are connected in series to a third connection point P3 and defined as a secondary series winding. The secondary side unit 4 is coupled to the secondary series winding, and the secondary side unit 4 comprises a rectifier circuit and an output capacitor Cout applied to a half-bridge type. The rectifier circuit is connected in parallel to the secondary series winding of the transformer unit 3, and the output capacitor Cout is coupled to the rectifier circuit and the secondary series winding. In the embodiment, the rectifier circuit of the secondary side unit 4 comprises a fifth switch QR1 and a sixth switch QR2 connected in series. The fifth switch QR1 and the sixth switch QR2 are connected to a fourth connection point P4. The output capacitor Cout is electrically connected between the third connection point P3 and the fourth connection point P4. The control unit 5 is electrically connected to the fifth switch QR1 and the sixth switch QR2 of the secondary side unit 4 and outputs a fifth control signal SR1 and a sixth control signal SR2 to control the conduction states of the fifth switch QR1 and the sixth switch QR2, respectively, to generate an output voltage Vout between the ends of the output capacitor Cout. The transformer unit 3 is shown as two transformers in the drawings, but the transformer unit 3 can be implemented by using one or more magnetic elements in combination with windings to implement the two transformers.

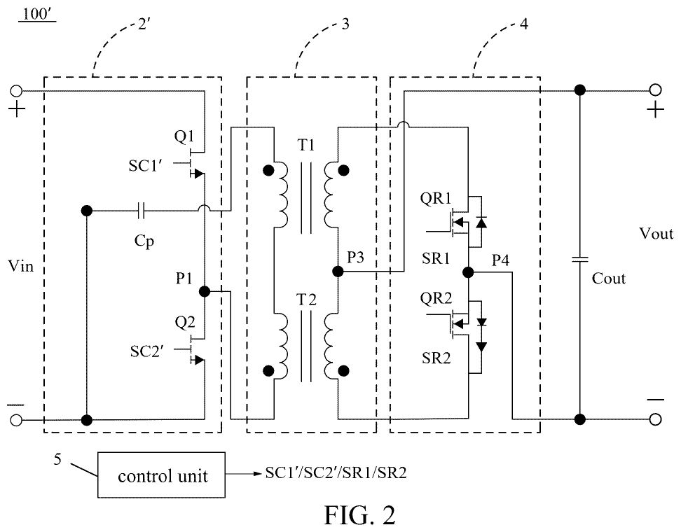

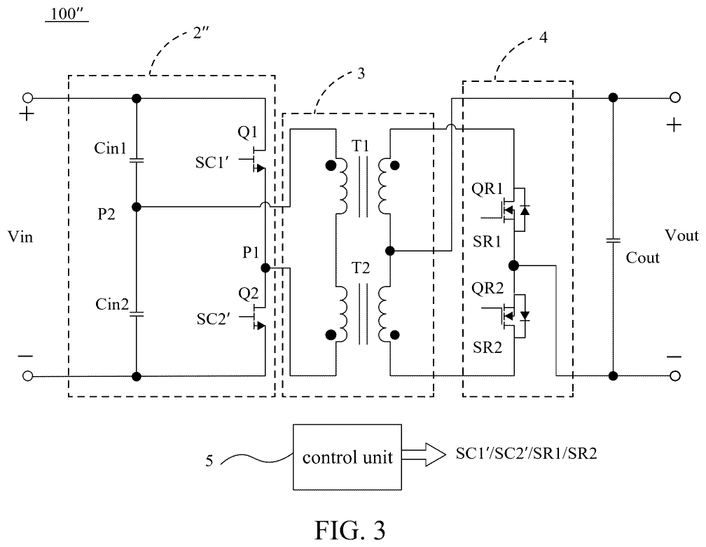

The circuit blocks in FIG. 1 can be implemented in a suitable manner according to different design considerations. For example, FIG. 2 is a circuit diagram of a power converter 100′ according to an embodiment of the present disclosure, which comprises an implementation of a two-transformer half bridge converter. A switch unit 2′ comprises a first bridge arm and an input capacitor Cp. The first bridge arm comprises a first switch Q1 and a second switch Q2. The first switch Q1 and the second switch Q2 are connected in series at a first connection point P1. The input capacitor Cp is coupled to the second switch Q2. The two primary sides of the two transformers T1 and T2 of the transformer unit 3 are defined as a primary series winding, and the primary series winding is coupled between the first connection point P1 and the input capacitor Cp. The control unit 5 is electrically connected to the first switch Q1 and the second switch Q2 of the switch unit 2 and outputs a first control signal SC1′ and a second control signal SC2′, respectively, used to control the conduction state of the first switch Q1 and the second switch Q2, wherein the first switch Q1 and the second switch Q2 are complementary to be turned on and off to perform power conversion operation. In addition, FIG. 3 is a circuit diagram of a power converter 100″ according to an embodiment of the present disclosure, which comprises the two-transformer half bridge converter. FIG. 3 generally uses the same component names and numbers as FIG. 2, with the differences as follows: The switch unit 2″ of the power converter 100″ comprises a first capacitor Cin1 and a second capacitor Cin2. The first capacitor Cin1 and the second capacitor Cin2 are connected in series at the second connection point P2 and defined as a capacitor group, and the capacitor group is connected in parallel to the first bridge arm. Two primary sides of the two transformers T1 and T2 of the transformer unit 3 are defined as a primary series winding, and the primary series winding is coupled between the first connection point P1 and the second connection point P2. The first control signal SC1′ and the second control signal SC2′ outputted by the control unit 5, respectively, control the first switch Q1 and the second switch Q2 to be turned on and off so as to perform the power conversion operation. In one embodiment, the duty cycles of the first control signal SC1′ and the second control signal SC2′ are set to be the same, between 0 and 50%, and have a phase difference of 180 degrees.

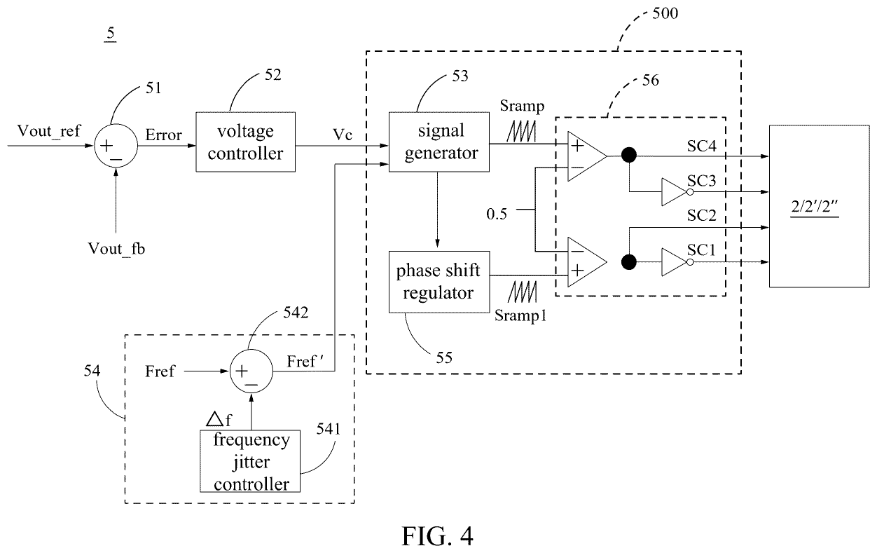

Please refer to FIG. 1 and FIG. 4. FIG. 4 is a circuit block diagram of a control unit of FIG. 1 according to the embodiment of the present disclosure. The control unit 5 comprises a subtractor 51, a voltage controller 52, a control signal generating circuit 500, and a frequency adjuster 54. In the embodiment, the control signal generating circuit 500 comprises a signal generator 53, a phase shift regulator 55, and a complementary signal generator 56. The subtractor 51 is coupled to the voltage controller 52 and is configured to receive a feedback voltage Vout_fb and a reference voltage Vout_ref to calculate a voltage error value Error. The feedback voltage Vout_fb is a feedback signal of an output voltage Vout of the secondary side unit 4 (for example, a feedback circuit is coupled to the output of the power converter 100 and converts the output voltage Vout into a suitable voltage level). The reference voltage Vout_ref is a reference voltage value corresponding to the desired output voltage value to set the output voltage Vout. For example, when the output voltage Vout is 48V, the corresponding Vout_ref is 2V. The control unit 5 can set the switch conduction states of the switch unit 2 and the secondary side unit 4 to make the output voltage Vout close to 48V and correspondingly make the feedback voltage Vout_fb as close to 2V as possible. The voltage controller 52 is coupled to the signal generator 53 and the voltage controller 52 is configured to generate a control variable Vc to the signal generator 53 according to the voltage error value Error generated by the subtractor 51. For example, the voltage controller 52 may use a suitable algorithm such as proportional-integral (PI), proportional-differential (PD), proportional-integral-differential (PID), etc., to generate the control variable Vc. The signal generator 53 is configured to provide a first control signal SC1, a second control signal SC2, a third control signal SC3 and a fourth control signal SC4 to the corresponding first switch Q1, second switch Q2, third switch Q3 and fourth switch Q4, respectively, to control their conduction states (for example, to control at least one of the conduction time and conduction frequency of the switches). In the embodiment, the control signals adopt a pulse width modulation (PWM) signal, and the voltage value of the output voltage Vout is correspondingly set by controlling the phase shift between the first switch Q1 and the fourth switch Q4 and the phase shift between the third switch Q3 and the second switch Q2. The frequency adjuster 54 is configured to provide a switching frequency Fref′ according to an input frequency Fref and a frequency jitter value Δf. The control signal generating circuit 500 generates control signals SC1-SC4 correspondingly according to Vc and Fref′. The signal generator 53 generates a ramp signal Sramp of a corresponding frequency according to the switching frequency Fref′. Sramp is passed through the phase shift regulator 55 to generate a phase shift ramp signal Sramp1. The two comparison circuits compare Sramp and Sramp1 with a suitable predetermined voltage value Vref, respectively. After passing through the inverting circuit, PWM signals corresponding to the required duty cycle, phase shift, and frequency are generated as the control signal SC1-SC4.

In the embodiment, the frequency adjuster 54 comprises a frequency jitter controller 541 and a comparator 542. The frequency jitter controller 541 is coupled to the comparator 542, and the frequency jitter controller 541 is configured to output a frequency jitter value Δf. The comparator 542 is configured to calculate the sum of the input frequency Fref and the frequency jitter value Δf and outputs a switching frequency Fref′. The equation is Fref′=Fref+Δf, where Fref is the input frequency, Fref′ is the output switching frequency, and Δf is the frequency jitter value. In a frequency increasing mode, the frequency jitter value Δf of the switching frequency increases. The operating method is to first transmit the predetermined input frequency Fref to the comparator 542, and add it with the frequency jitter value Δf to output the switching frequency Fref′. The output switching frequency Fref′ is then transmitted to the comparator 542 as the next input frequency Fref and is added with the increasing frequency jitter value Δf to output the updated switching frequency Fref′, so as to achieve the effect of gradually increasing the switching frequency Fref′. In a frequency decreasing mode, the frequency jitter value Δf of the switching frequency is decreasing. The operating method is to first transmit the predetermined input frequency Fref to the comparator 542 and add it with the frequency jitter value Δf to output the switching frequency Fref. The output switching frequency Fref′ is then transmitted to the comparator 542 as the next input frequency Fref, and added with the decreasing frequency jitter value Δf to output the updated switching frequency Fref′, so as to achieve the effect of gradually decreasing the switching frequency Fref′. The switching frequency Fref′ can be set in the frequency increasing mode and the frequency decreasing mode through the frequency adjuster 54, so that the switching frequencies of the control signals SC1, SC2, SC3 and SC4 provided by the signal generator 53 increase or decrease between a minimum threshold value and a maximum threshold value.

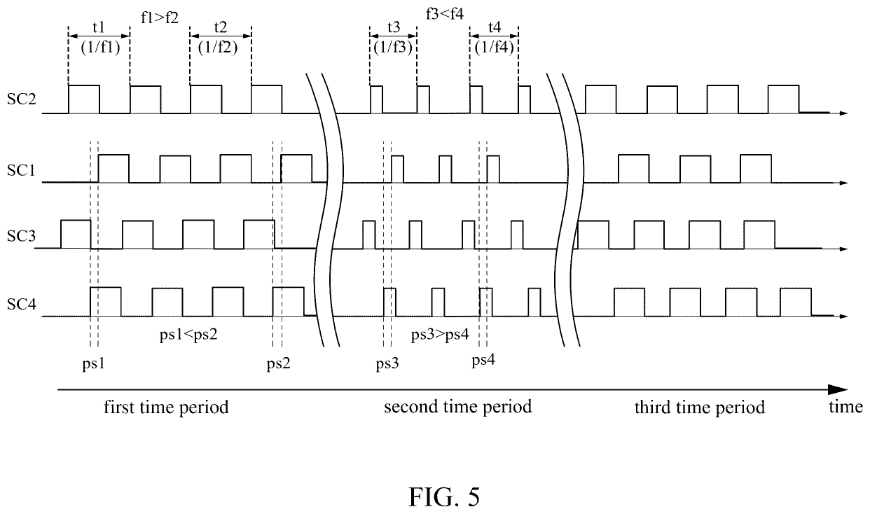

FIG. 5 is a timing diagram of the control signals SC1-SC4 of FIG. 4 according to the embodiment of the present disclosure. The control unit 5 sets the control signal SC1 to be complementary to the control signal SC2 and the control signal SC3 to be complementary to the control signal SC4, and the phase shift between the control signals SC1 and SC4 is corresponding to the phase shift between the control signals SC3 and SC2. In the first time period in FIG. 5, the control unit 5 sets the switching frequencies of the control signals SC1, SC2, SC3, and SC4 to be in the frequency decreasing mode, wherein the period t1 corresponds to the switching frequency 1/f1 and the period t2 corresponds to the switching frequency 1/f2. In the frequency decreasing mode, the period t1<the period t2, which means that the switching frequency f1>the switching frequency f2, that is, the switching frequency decreases gradually, and the phase shift increases gradually, such as the phase shift ps1<the phase shift ps2. In the second time period in FIG. 5, the control unit 5 sets the switching frequencies of the control signals SC1, SC2, SC3, and SC4 to be in the frequency increasing mode, wherein the period t3 corresponds to the switching frequency 1/f3 and the period t4 corresponds to the switching frequency 1/f4. In the frequency increasing mode, the period t3>the period t4, which means that the switching frequency f3<the switching frequency f4, that is, the switching frequency increases gradually, and the phase shift decreases gradually, such as the phase shift ps3>the phase shift ps4. In the third time period in FIG. 5, the switching frequency is switched to the frequency decreasing mode as in the first time period. In the embodiment, the control unit 5 sets the switching frequencies of the control signals to vary in a range of Fref+Δfmin to Fref+Δfmax. For example, Fref is 250 kHz, Δfmin is −50 kHz, Δfmax is 50 kHz, and the range of the switching frequency is 200 kHz to 300 KHz.

In another embodiment, the control unit 5 sets the control signal SC1 to be complementary to the control signal SC2 and the control signal SC3 to be complementary to the control signal SC4. The phase shift between the control signals SC1 and SC4 is corresponding to the phase shift between the control signals SC3 and SC2. The control unit 5 sets the switching frequencies of the control signals SC1, SC2, SC3, and SC4 to operate alternately in the frequency decreasing mode or the frequency increasing mode. When operating in one of the frequencies decreasing mode and the frequency increasing mode, the control unit 5 maintains the phase shifts of the control signals SC1 and SC4 and the phase shifts of the control signals SC3 and SC2 to be the same, without changing with the frequency increasing or decreasing, so as to further simplify the complexity of control. Although in the embodiment, the output voltage of the power converter may generate some noise, in applications where the output voltage noise requirement is lower and the control complexity and electromagnetic interference need to be reduced, the alternating operation mode of the frequency decreasing mode and the frequency increase mode of the embodiment can still bring beneficial technical effects.

In one embodiment, when the frequency jitter value Δf generated by the frequency jitter controller 541 gradually increases, the frequency adjuster 54 operates in the frequency increasing mode until the frequency jitter value reaches a predetermined maximum value (e.g., 50 kHz); when the frequency jitter value Δf generated by the frequency jitter controller 541 gradually decreases, the frequency adjuster 54 operates in a frequency decreasing mode until the frequency jitter value reaches a predetermined minimum value (e.g., −50 kHz). By operating the frequency adjuster 54 alternately in the frequency increasing mode and the frequency decreasing mode, the switching frequencies of the switch unit (2, 2′, 2″) and the electromagnetic interference signals of the multiples of the switching frequencies can be dispersed at various frequencies at different time periods, thereby reducing the energy concentration in a specific frequency band of the control signals SC1-SC4 and effectively reducing the energy peak of the electromagnetic interference in a single frequency band.

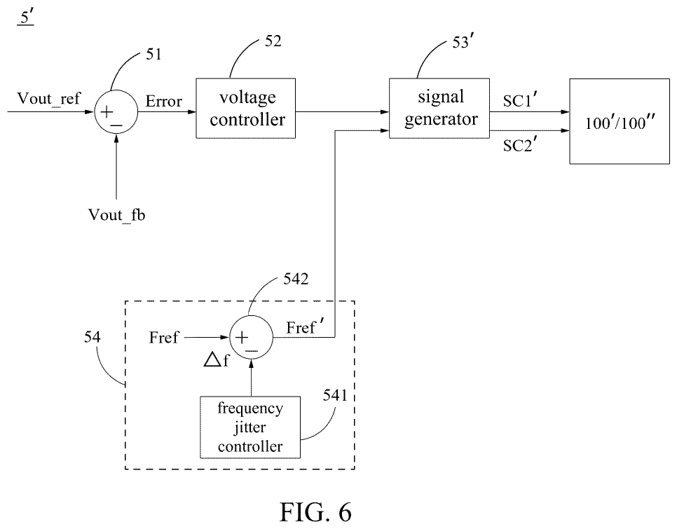

FIG. 6 is a circuit block diagram of a control unit of FIG. 2 or FIG. 3 according to the embodiment of the present disclosure. The control unit 5′ comprises a subtractor 51, a voltage controller 52, a signal generator 53′ and a frequency adjuster 54, wherein the subtractor 51 is coupled to the voltage controller 52 and is configured to receive a feedback voltage Vout_fb and a reference voltage Vout_ref to calculate a voltage error value Error. The feedback voltage Vout_fb is a feedback signal of an output voltage Vout of the secondary side unit 4. The voltage controller 52 is coupled to the signal generator 53′, and the voltage controller 52 is configured to generate a control value Vc to the signal generator 53′ according to the voltage error value Error generated by subtractor 51. The signal generator 53′ is configured to provide a first control signal SC1′ and a second control signal SC2′ to the corresponding first switch Q1 and second switch Q2, respectively, so as to control at least one of the conduction time and conduction frequency of the first switch Q1 and the second switch Q2.

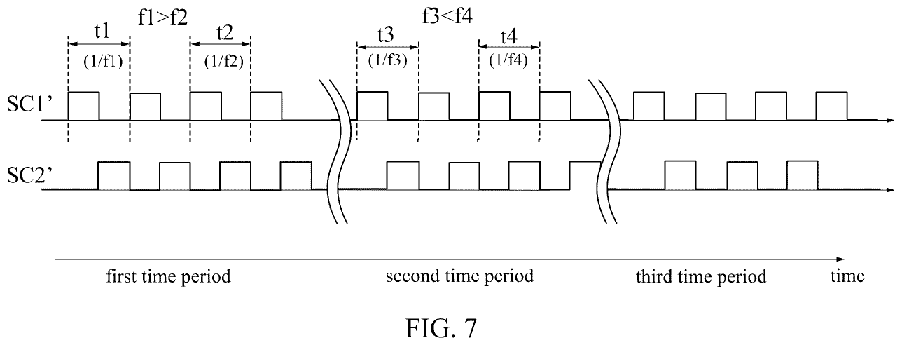

FIG. 7 is a timing diagram of the control signals of FIG. 6 according to the embodiment of the present disclosure, wherein the phase difference between the control signal SC1′ and the control signal SC2′ of the control unit 5′ is 180 degrees, and the signal generator 53 generates PWM signals corresponding to the required duty cycle as the control signals SC1′-SC2′. Furthermore, the frequency adjuster 54 can determine whether the switching frequency is in the frequency increasing mode and the frequency decreasing mode, so that the switching frequencies of the control signals SC1′ and SC2′ provided by the signal generator 53 are repeatedly increased and decreased between a minimum threshold value and a maximum threshold value. In the first time period in FIG. 7, the control unit 5′ sets the switching frequencies of the control signals SC 1′ and SC2′ to be in the frequency decreasing mode, wherein the period t1 corresponds to the switching frequency 1/f1, and the period t2 corresponds to the switching frequency 1/f2. In the frequency decreasing mode, period t1<period t2, which means that the switching frequency f1>switching frequency f2, i.e., the switching frequency decreases gradually. In the second time period in FIG. 7, the control unit 5′ sets the switching frequency of the control signals SC1′ and SC2′ to be in the frequency increasing mode, wherein period t3 corresponds to the switching frequency 1/f3, and period t4 corresponds to the switching frequency 1/f4. In the frequency increasing mode, period t3>period t4, which means that the switching frequency f3<switching frequency f4, i.e., the switching frequency increases gradually. In the third time period in FIG. 7, the control unit 5′ sets the switching frequencies of the control signals SC1 and SC2 to be in the frequency decreasing mode.

According to the embodiment of the power converter of the present disclosure, an operating method of the power converter with low electromagnetic interference is provided, wherein the power converter comprises a first bridge arm, two transformers T1 and T2, a secondary side unit 4, a signal generator 53, and a frequency adjuster 54 as provided in the above embodiment. The frequency adjuster 54 is operated between the frequency increasing mode and the frequency decreasing mode, so that the frequency adjuster 54 outputs a switching frequency Fref′ correspondingly according to the input frequency Fref and the frequency jitter value Δf. In the frequency increasing mode, the frequency jitter value Δf generated by the frequency jitter controller 541 gradually increases, and the frequency adjuster 54 operates in the frequency increasing mode until the frequency jitter value reaches a predetermined maximum value (e.g., 50 kHz) and then the frequency adjuster operates in the frequency decreasing mode. In the frequency decreasing mode, the frequency jitter value Δf generated by the frequency jitter controller 541 gradually decreases, and the frequency adjuster 54 operates in the frequency decreasing mode until the frequency jitter value reaches a predetermined minimum value (e.g., −50 kHz), and then the frequency adjuster operates in the frequency increasing mode. The signal generator 53 is used to receive the switching frequencies, and the frequencies to which the control signals SC1-SC4 correspond are set according to the switching frequencies. The signal generator 53 provides the control signals SC1-SC4 to the corresponding switches Q1-Q4, or provides the control signals SC1′, SC2′ to the corresponding switches Q1, Q2, so as to control at least one of the conduction state and conduction frequency of the switches.

As described above, through disposing of the control units 5 and 5′ to use the frequency jitter mechanism to operate the switching frequencies of the frequency adjuster 54 between the frequency increasing mode and the frequency decreasing mode, the switching frequencies of the power converter are changed within a certain frequency range. The switching frequencies and the electromagnetic interference signals of the multiples of the switching frequencies can be dispersed at various frequencies at different time periods, thereby reducing the energy concentration in a specific frequency band of the control signal, which can effectively reduce the energy peak of the electromagnetic interference in a single frequency band.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

1. A power converter, comprising:
a first bridge arm comprising a first switch and a second switch connected in series at a first connection point;
two transformers, wherein two primary sides of the two transformers are connected in series and defined as a primary series winding coupled to the first connection point, and two secondary sides of the two transformers are connected in series and defined as a secondary series winding;
a secondary side unit coupled to the secondary series winding;
a signal generator configured to provide a plurality of control signals to the first switch and the second switch, respectively, so as to control at least one of a conduction state and conduction frequency of the first switch and the second switch; and
a frequency adjuster configured to provide a switching frequency correspondingly according to an input frequency and a frequency jitter value;
wherein the signal generator receives the switching frequency and sets frequencies of the plurality of control signals according to the switching frequency; the frequency adjuster is configured to operate in one of a frequency increasing mode and a frequency decreasing mode; in the frequency increasing mode, the frequency jitter value is increased until the frequency jitter value reaches a predetermined maximum value, and then the frequency adjuster operates in the frequency decreasing mode; in the frequency decreasing mode, the frequency jitter value is reduced until the frequency jitter value reaches a predetermined minimum value, and then the frequency adjuster operates in the frequency increasing mode.

2. The power converter according to claim 1, wherein the power converter further comprises a second bridge arm connected in parallel to the first bridge arm; the second bridge arm comprises a third switch and a fourth switch; the third switch and the fourth switch are connected in series at a second connection point; and the primary series winding is coupled between the first connection point and the second connection point.

3. The power converter according to claim 2, wherein the signal generator generates a first control signal, a second control signal, a third control signal, and a fourth control signal to control the first switch, the second switch, the third switch, and the fourth switch, respectively; the first control signal is complementary to the second control signal, and the third control signal is complementary to the fourth control signal.

4. The power converter according to claim 1, further comprising an input capacitor coupled to the second switch, and the primary series winding is coupled between the first connection point and the input capacitor.

5. The power converter according to claim 1, further comprising a first capacitor and a second capacitor connected in series at a second connection point and defined as a capacitor group connected in parallel to the first bridge arm; and the primary series winding is coupled between the first connection point and the second connection point.

6. The power converter according to claim 1, further comprising a voltage controller coupled to the signal generator to generate a control variable for the signal generator.

7. The power converter according to claim 6, further comprising a subtractor coupled to the voltage controller; the subtractor is configured to receive a feedback voltage and a reference voltage to calculate an error value; the feedback voltage is generated according to an output voltage of the secondary side unit; and the reference voltage is corresponding to a reference voltage value of the output voltage.

8. The power converter according to claim 1, wherein the frequency adjuster comprises a frequency jitter controller and a comparator coupled to the frequency jitter controller; the frequency jitter controller is configured to output a frequency jitter value; and the comparator is configured to calculate a sum of the frequency jitter value and the switching frequency generated by the frequency adjuster.

9. The power converter according to claim 1, wherein the secondary side unit comprises a half-bridge rectifier circuit and an output capacitor; the output capacitor is coupled to the half-bridge rectifier circuit; and the output capacitor is configured to couple a load.

10. An operating method of a power converter, wherein the power converter comprises a first bridge arm comprising a first switch and a second switch connected in series at a first connection point; two transformers, wherein two primary sides of the two transformers are connected in series and defined as a primary series winding coupled to the first connection point, and two secondary sides of the two transformers are connected in series and defined as a secondary series winding; a secondary side unit coupled to the secondary series winding; a signal generator configured to provide a plurality of control signals to the first switch and the second switch, respectively; and a frequency adjuster, the operating method comprising:
operating the frequency adjuster in a frequency increasing mode and a frequency decreasing mode to make the frequency adjuster provide a switching frequency correspondingly according to an input frequency and a frequency jitter value; in the frequency increasing mode, the frequency jitter value is increased until the frequency jitter value reaches a predetermined maximum value, and then the frequency adjuster operates in the frequency decreasing mode; and in the frequency decreasing mode, the frequency jitter value is reduced until the frequency jitter value reaches a predetermined minimum value, and then the frequency adjuster operates in the frequency increasing mode;
receiving the switching frequency through the signal generator and setting frequencies of a plurality of control signals according to the switching frequency; and
providing the plurality of control signals through the signal generator to a first switch and a second switch of the first bridge arm, respectively, so as to control at least one of a conduction state and conduction frequency of the first switch and the second switch.

11. The operating method of a power converter according to claim 10, further comprising:
generating a first control signal, a second control signal, a third control signal, and a fourth control signal by the signal generator; and
controlling the first switch, the second switch, the third switch, and the fourth switch, respectively by the first control signal, the second control signal, the third control signal, and the fourth control signal, wherein the first control signal is complementary to the second control signal, and the third control signal is complementary to the fourth control signal.

12. The operating method of a power converter according to claim 10, wherein the power converter comprises a voltage controller coupled to the signal generator, the operating method further comprising:
generating a control variable for the signal generator by the voltage controller.

13. The operating method of a power converter according to claim 12, wherein the power converter comprises a subtractor coupled to the voltage controller, the operating method further comprising:
receiving a feedback voltage and a reference voltage to calculate an error value by the subtractor, wherein the feedback voltage is generated according to an output voltage of the secondary side unit and the reference voltage is corresponding to a reference voltage value of the output voltage.

14. The operating method of a power converter according to claim 10, wherein the frequency adjuster comprises a frequency jitter controller and a comparator coupled to the frequency jitter controller, the operating method further comprising:
outputting a frequency jitter value by the frequency jitter controller; and
calculating a sum of the frequency jitter value and the switching frequency generated by the frequency adjuster through the comparator.
